(19) United States
(12) Patent Application Publication
(10) Pub. No.: US 2007/0175497 A1
(43) Pub. Date: Aug. 2, 2007

(54) Apparatus having heating portion in chemical bath for substrate wet treatment and method of heating chemical for substrate wet treatment using the apparatus

(75) Inventors: Byeong-chu Lee, Hwaseong-si (KR); Dong-chul Heo, Seongnam-si (KR); Mo-hyun Cho, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/638,003

(22) Filed: Dec. 13, 2006

(30) Foreign Application Priority Data
Feb. 1, 2006 (KR) 10-2006-0009808

(51) Int. Cl. B08B 7/04; B08B 3/00

(52) U.S. Cl. 134/18; 134/105; 134/56 R

(57) ABSTRACT

There are provided an apparatus having a heating portion in a chemical bath for substrate wet treatment and a method of heating a chemical for substrate wet treatment using the apparatus. The apparatus includes a chemical bath containing a chemical for substrate wet treatment. A heating portion is installed in the chemical bath, and the heating portion includes a heating element and a housing accommodating the heating element. An inert gas is filled in the housing.

### CROSS-REFERENCE TO RELATED PATENT APPLICATION

This application claims the benefit of Korean Patent Application No. 10-2006-0009808, filed on Feb. 1, 2006, in the Korean Intellectual Property Office, the contents of which are incorporated herein in their entirety by reference.

### BACKGROUND OF THE INVENTION

1. Field of the Invention

The present invention relates to an apparatus for substrate wet treatment, and more particularly, to an apparatus having a heating portion in a chemical bath for substrate wet treatment.

2. Description of the Related Art

A substrate wet treating apparatus is a device for cleaning or etching a substrate. For this, the substrate wet treating apparatus includes a chemical bath containing a chemical for cleaning or etching the substrate. The chemical can be heated to a predetermined temperature for smooth cleaning or etching.

The chemical can be heated by an indirect heating method or a direct heating method. In the indirect heating method, the chemical is heated outside the chemical bath and then supplied to the chemical bath. In the direct heating method, the chemical is directly heated in the chemical bath. In the indirect heating method, since heat is dissipated from the chemical while the heated chemical is supplied to the chemical bath, the chemical in the chemical bath cannot have a high temperature. Therefore, the direct heating method is currently in more widespread use.

However, in the direct heating method, a heating portion is directly installed in the chemical bath. Therefore, the heating portion can be damaged by direct contact with the chemical, causing possible contamination of the chemical and fire.

### SUMMARY OF THE INVENTION

The present invention provides an apparatus for wet treatment of a substrate, the apparatus being designed to prevent contamination of a chemical inside a chemical bath and to prevent fire.

The present invention also provides a method of heating a chemical for wet treatment of a substrate, the method being designed to prevent contamination of a chemical inside a chemical bath and to prevent fire.

According to an aspect of the present invention, there is provided an apparatus for wet treatment of a substrate, including: a chemical bath containing a chemical for treating the substrate; a heating portion installed in the chemical bath, the heating portion including a heating element and a housing accommodating the heating element; and an inert gas filled in the housing.

According to the invention, even when the housing is corroded by the chemical and thus a pin hole may be formed through the housing, the chemical cannot enter the housing through the pin hole since the inert gas filled in the housing is discharged through the pin hole in the form of bubbles to prevent inflow of the chemical. As a result, the chemical does not make direct contact with the heating element, so that contamination of the chemical or fire are prevented since the heating element is not corroded by the chemical.

The apparatus may further include a gas pressure sensor gauging a pressure of the inert gas filled in the housing. The gas pressure sensor may generate an alarm when the gauged pressure is lower than a reference pressure. Therefore, an operator can be immediately notified when a pin hole is formed through the housing, so that necessary actions can be promptly taken.

The apparatus may further include a control board connected with the gas pressure sensor. The control board may stop operation of the heating element when the gauged pressure by the gas pressure sensor is lower than a reference pressure.

The apparatus may further include an inert gas supply tube and an inert gas discharge-tube that are connected to the housing. The apparatus may further include a gas pressure sensor connected with the inert gas discharge tube. The gas pressure sensor can generate an alarm when a gauged pressure is lower than a reference pressure. The apparatus can further comprise a control board connected with the gas pressure sensor, the control board stopping operation of the heating element when a gauged pressure by the gas pressure sensor is lower than a reference pressure. The apparatus may further include a gas regulator connected with the inert gas supply tube. The apparatus may further include a mass flow controller (MFC) connected with the inert gas supply tube.

According to another aspect of the present invention, there is provided a method of heating a chemical for wet treatment of a substrate, the method including: installing a heating portion in a chemical bath containing the chemical, the heating portion including a heating element and a housing accommodating the heating element; and filling the housing with an inert gas.

According to the invention, even when the housing is corroded by the chemical and thus a pin hole is formed through the housing, the chemical cannot enter the housing through the pin hole since the inert gas filled in the housing is discharged through the pin hole in the form of bubbles to prevent inflow of the chemical. As a result, the chemical does not make direct contact with the heating element, so that contamination of the chemical or a fire can be prevented since the heating element is not corroded by the chemical.

The method may further include gauging a pressure of the inert gas filled in the housing. The method may further include generating an alarm when the gauged pressure is lower than a reference pressure. Therefore, an operator can be immediately notified when a pin hole is formed through the housing, so that necessary actions can be promptly taken. The method may further include stopping operation of the heating element when the gauged pressure is lower than a reference pressure.

The filling of the housing may include discharging the inert gas from the housing while supplying the inert gas to the housing. In this case, the method may further include gauging a pressure of the discharging inert gas. The method may further include generating an alarm when the gauged pressure is lower than a reference pressure. The method may further include stopping operation of the heating element when the gauged pressure is lower than a reference pressure. The inert gas supplied to the housing may be kept at a constant pressure and flow rate.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of an apparatus for substrate wet treatment according to an embodiment of the present invention.

FIG. 2 is a schematic diagram showing a portion of the apparatus depicted in FIG. 1.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein.

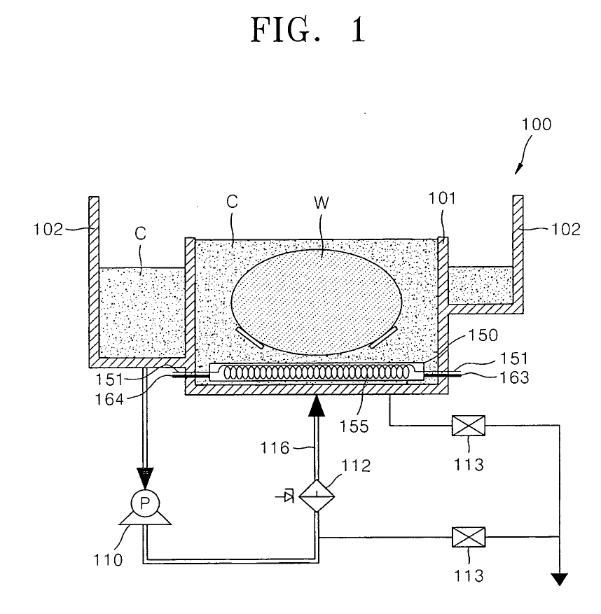

FIG. 1 is a schematic diagram of an apparatus 100 for substrate wet treatment according to an embodiment of the present invention.

Referring to FIG. 1, the substrate wet treating apparatus 100 includes a chemical bath containing a chemical (C) for treating a substrate. The chemical bath may include an inner chemical bath 101 and an outer chemical bath 102. The inner chemical bath 101 has an opened top for receiving a substrate (W). The substrate (W) may a substrate for a semiconductor device. The outer chemical bath 102 may enclose the inner chemical bath 101 and include a lid on a top.

The chemical (C) contained in the inner chemical bath 101 is used for cleaning the substrate (W) or etching a layer formed on the substrate (W). Thus, floating particles may exist in the chemical (C) of the inner chemical bath 101. The chemical (C) is continuously supplied to the inner chemical bath 101 through a circulation tube 116. As a result, the chemical (C) inside the inner chemical bath 101 overflows down to the outer chemical bath 102, together with the floating particles. Then, the chemical (C) is again supplied to the inner chemical bath 101 from the outer chemical bath 102 through the circulation tube 116. In the circulation tube 116, the chemical (C) passes through a circulation pump 110 and a circulation filter 112. The circulation filter 112 removes the floating particles or other foreign substances from the chemical (C) to keep the chemical (C) clean.

Drain valves 113 may be connected to the circulation tube 116 and the inner chemical bath 101, respectively. If necessary, the chemical (C) can be discharged to the outside by opening the drain valve 113.

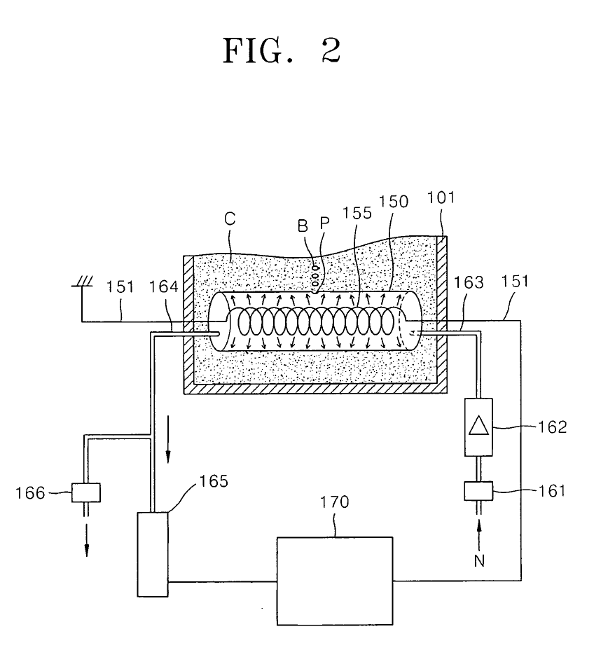

FIG. 2 is a schematic diagram showing a portion of the substrate wet etching apparatus 100 depicted in FIG. 1.

Referring to FIG. 2, a heating portion is installed in the chemical bath, specifically in the inner chemical bath 101. The heating portion includes a heating element 155 and a housing 150 accommodating the heating element 155. The heating element 155 may be a metal coil. The heating element 155 is connected with an electric wire 151. One end of the electric wire 151 may be connected to a control board 170. The control board 170 controls power to the electric wire 151.

The housing 150 may be formed of quartz or Teflon, and an inert gas is filled in the housing 150. The housing 150 is in direct contact with the chemical (C). The chemical (C) may be HF, H₃PO₃, HCl, HNO₃, NaCl, H₂SO₄, NH₄OH, or NaOH. Since most of the substances referred to as the chemical (C) are strongly corrosive (strongly acid or alkaline), the housing 150 can be corroded. As a result, a pin hole (P) may be formed through the housing 150. In this case, the inert gas filled in the housing 150 is discharged to the chemical (C) through pin hole (P), and the discharged inert gas is emitted to the outside through the chemical (C) in the form of bubbles (B).

Therefore, the chemical (C) can be prevented from entering the housing 150 through the pin hole (P), and thus the heating element 155 can be prevented from making contact with the chemical (C). As a result, the heating element 155 is not corroded by the chemical (C), and thus the inner chemical bath 101 is not contaminated by the corrosion, thereby preventing the substrate (W) from being contaminated. Further, since the heating element 155 is not in contact with the chemical (C), a spark or electric short circuit can be prevented to reduce the possibility of fire.

Furthermore, since the inert gas is not reactive, the chemical (C) may be not contaminated by the inert gas. The inert gas may be nitrogen.

To allow the inert gas to be discharged from the housing 150 to the outside through the chemical (C), the pressure of the inter gas inside the housing 150 may be higher than the outside pressure. If the outside pressure is equal to the atmospheric pressure, the pressure of the inert gas may be higher than the atmospheric pressure.

A gas pressure sensor 165 is installed to gauge the pressure of the inert gas filled in the housing 150. The gas pressure sensor 165 may generate an alarm when the gauged pressure of the inert gas is lower than a reference pressure. The reference pressure is a pressure of the inert gas filled inside the housing 150 when the pin hole (P) is not formed in the housing 150. Therefore, when the pin hole (P) is formed in the housing 150, the pressure of the inert gas in the housing 150 decreases below the reference pressure. In this case, the gas pressure sensor 165 may detect the pressure drop and generate an alarm. Therefore, an operator can be immediately notified whether the pin hole (P) is formed in the housing 150, so that the operator can take necessary action promptly.

In addition, the control board 170 may be connected with the gas pressure sensor 165. When the pressure of the inert gas gauged by the gas pressure sensor 165 is lower than the reference pressure, the control board 170 may interrupt the operation of the heating element 155. In detail, the control board 170 can interrupt power to the electric wire 151 connected to the heating element 155. Therefore, heating the chemical (C) contained in the inner chemical bath 101 can be stopped. Further, the control board 170 can suspend the process by preventing an additional substrate (W) from being inserted into the inner chemical bath 101.

The housing 150 may be connected with an inert gas supply tube 163 and an inert gas discharge tube 164. Therefore, while the inert gas is supplied to the housing 150 through the inert gas supply tube 163 and simultaneously discharged from the housing 150 through the inert gas discharge tube 164, the housing can be filled with the inert gas.

In this case, the gas pressure sensor 165 may be connected with the inert gas discharge tube 164 to gauge the pressure of the inert gas when the inert gas is discharged from the housing 150. Further, a discharge cap 166 may be installed on the inert gas discharge tube 164. The discharge cap 166 is opened when the pressure inside the housing 150 increases excessively. Therefore, extreme conditions of pressure inside the housing 150 can be prevented.

A gas regulator 161 may be connected with the inert gas supply tube 163. The gas regulator 161 keeps the pressure of the inert gas at a constant level when the inert gas is supplied to the housing 150. Further, a mass flow controller (MFC) 162 may be connected with the inert gas supply tube 163. The MFC 162 may keep the flow rate of the inert gas to the housing 150 at a constant level. Further, when the flow rate of the inert gas to the housing 150 exceeds a reference level, the MFC 162 may generate an alarm.

As described above, according to the present invention, even when the housing is corroded by the chemical and thus a pin hole is formed through the housing, the chemical cannot enter the housing through the pin hole since the inert gas filled in the housing is discharged through the pin hole in the form of bubbles to prevent inflow of the chemical. Therefore, the chemical does not make direct contact with the heating element, so that contamination of the chemical and fire can be prevented since the heating element is not corroded by the chemical.

Further, when the gas pressure sensor is installed, an operator can be immediately notified when the pin hole is formed through the housing. Therefore, necessary actions can be promptly taken.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for wet treatment of a substrate, comprising:
a chemical bath containing a chemical for treating the substance;
a heating portion installed in the chemical bath, the heating portion including a heating element and a housing accommodating the heating element; and
an inert gas filled in the housing.

2. The apparatus of claim 1, further comprising a gas pressure sensor gauging a pressure of the inert gas filled in the housing.

3. The apparatus of claim 2, wherein the gas pressure sensor generates an alarm when the gauged pressure is lower than a reference pressure.

4. The apparatus of claim 2, further comprising a control board connected with the gas pressure sensor, the control board stopping operation of the heating element when the gauged pressure by the gas pressure sensor is lower than a reference pressure.

5. The apparatus of claim 1, further comprising an inert gas supply tube and an inert gas discharge tube that are connected to the housing.

6. The apparatus of claim 5, further comprising a gas pressure sensor connected with the inert gas discharge tube.

7. The apparatus of claim 6, wherein the gas pressure sensor generates an alarm when a gauged pressure is lower than a reference pressure.

8. The apparatus of claim 6, further comprising a control board connected with the gas pressure sensor, the control board stopping operation of the heating element when a gauged pressure by the gas pressure sensor is lower than a reference pressure.

9. The apparatus of claim 5, further comprising a gas regulator connected with the inert gas supply tube.

10. The apparatus of claim 5, further comprising a mass flow controller (MFC) connected with the inert gas supply tube.

11. A method of heating a chemical for wet treatment of a substrate, the method comprising:
installing a heating portion in a chemical bath, the heating portion including a heating element and a housing accommodating the heating element; and
filling the housing with an inert gas.

12. The method of claim 11, further comprising gauging a pressure of the inert gas filled in the housing.

13. The method of claim 12, further comprising generating an alarm when the gauged pressure is lower than a reference pressure.

14. The method of claim 12, further comprising stopping operation of the heating element when the gauged pressure is lower than a reference pressure.

15. The method of claim 11, wherein the filling of the housing comprises discharging the inert gas from the housing while supplying the inert gas to the housing.

16. The method of claim 15, further comprising gauging a pressure of the discharging inert gas.

17. The method of claim 16, further comprising generating an alarm when the gauged pressure is lower than a reference pressure.

18. The method of claim 16, further comprising stopping operation of the heating element when the gauged pressure is lower than a reference pressure.

19. The method of claim 15, wherein the inert gas supplied to the housing is kept at a constant pressure and flow rate.
